(19) United States
(12) Patent Application Publication
(10) Pub. No.: US 2022/0292365 A1
(43) Pub. Date: Sep. 15, 2022

(54) CONVOLUTIONAL ARITHMETIC PROCESSING DEVICE AND CONVOLUTIONAL ARITHMETIC PROCESSING SYSTEM

(71) Applicant: KABUSHIKI KAISHA TOSHIBA, Tokyo (JP)

(72) Inventor: Mizuki ONO, Yokohama (JP)

(73) Assignee: KABUSHIKI KAISHA TOSHIBA, Tokyo (JP)

(21) Appl. No.: 17/447,232

(22) Filed: Sep. 9, 2021

(30) Foreign Application Priority Data
Mar. 15, 2021 (JP) 2021-041120

(51) Int. Cl. G06N 3/10; G06N 3/04; G06K 9/36

(52) U.S. Cl. CPC G06N 3/10; G06N 3/04; G06K 9/36

(57) ABSTRACT

A convolutional arithmetic processing device includes a convolutional arithmetic processor and a storage device. The convolutional arithmetic processor performs a first convolutional arithmetic process of a convolutional neural network on numerical values of a first three-dimensional array, using a type of kernel formed of numerical values of a second three-dimensional array, where a number of the type is represented by a second numerical value with a stride represented by a third numerical value in a first direction and a stride represented by a fourth numerical value in a second direction. The storage device stores at least part of the numerical values of the first three-dimensional array.

### CROSS-REFERENCE TO RELATED APPLICATIONS

This application is based upon and claims the benefit of priority from Japanese Patent Application No. 2021-041120, filed Mar. 15, 2021, the entire contents of which are incorporated herein by reference.

### FIELD

Embodiments described herein relate generally to a convolutional arithmetic processing device and a convolutional arithmetic processing system.

### BACKGROUND

In a convolutional neural network, a storage device for temporarily storing a numerical value that is output of each layer, that is, a numerical value that is input of a next layer is required. Specifically, when a pipeline process is performed in unit of layer, a storage device including a memory that stores numerical values that are outputs of all layers is required. Then, in order to be able to simultaneously perform writing of a numerical value that is output of the process in a specific layer and reading of a numerical value that is input of the process in a next layer of the specific layer, the storage device is required to have a double buffer configuration, and thus a memory that stores twice as many numerical values as the numerical values that are outputs of all layers is required.

In order to reduce a size of the memory required, it has been attempted to store, instead of all of the output for each layer, only some numerical values required to perform the process of the next layer among the outputs, but the reduction in the size of the memory required is not sufficient.

Comparing a case where the output of each layer is stored in a storage or the like outside a chip that performs the arithmetic process with a case where the output of each layer is stored in a memory inside the chip, the former is not preferable from the viewpoint of high-speed operation because the former has a longer time required for reading and writing than the latter. Therefore, it is necessary to use a memory in the chip as the memory.

As a result, downsizing of the arithmetic processing device including the chip that performs the arithmetic process and reduction in manufacturing cost of the arithmetic processing device and the arithmetic processing system including the arithmetic processing device are not achieved.

In the existing arithmetic processing device, a reduction in a delay from the start of reading the input of the convolutional neural network to the output of the result of the convolutional arithmetic process, that is, a reduction in a latency, is also not sufficient. As a result, implementation of an arithmetic processing system with a short latency is not achieved.

In the conventional technology, it is not possible to reduce the size of the memory or the latency in the convolutional arithmetic processing device.

### BRIEF DESCRIPTION OF THE DRAWINGS

FIG. 1 is a schematic diagram illustrating an example of a convolutional neural network.

FIG. 2 schematically illustrates a pipeline process in the convolutional neural network.

FIG. 3 schematically illustrates an example of a method of using a storage device in the convolutional neural network.

FIG. 4 schematically illustrates an example of a convolutional arithmetic processing device according to a first embodiment.

FIG. 5 schematically illustrates an example of a method of using a storage device in the convolutional neural network according to the first embodiment.

FIG. 6 schematically illustrates another example of a method of using a storage device in the convolutional neural network according to the first embodiment.

FIGS. 7A and 7B schematically illustrate a modified example of the convolutional arithmetic processing device according to the first embodiment.

FIG. 8 schematically illustrates an example of a convolutional arithmetic processing system according to a second embodiment.

FIG. 9 schematically illustrates an example of division of an output of the convolutional neural network according to the second embodiment.

FIGS. 10A, 10B, 10C, 10D, and 10E schematically illustrate an example of division of an input of the convolutional neural network according to the second embodiment.

FIG. 11 schematically illustrates a modified example of division of the output of the convolutional neural network according to the second embodiment.

FIGS. 12A, 12B, 12C, 12D, and 12E schematically illustrate a modified example of division of the input of the convolutional neural network according to the second embodiment.

FIGS. 13A and 13B schematically illustrate a modified example of division of the output of the convolutional neural network according to the second embodiment.

### DETAILED DESCRIPTION

Various embodiments will be described hereinafter with reference to the accompanying drawings.

The disclosure is merely an example and is not limited by contents described in the embodiments described below. Modification which is easily conceivable by a person of ordinary skill in the art comes within the scope of the disclosure as a matter of course. In order to make the description clearer, the sizes, shapes, and the like of the respective parts may be changed and illustrated schematically in the drawings as compared with those in an accurate representation. Constituent elements corresponding to each other in a plurality of drawings are denoted by like reference numerals and their detailed descriptions may be omitted unless necessary.

In general, according to one embodiment, a convolutional arithmetic processing device comprises a convolutional arithmetic processor and a storage device. The convolutional arithmetic processor is configured to perform a first convolutional arithmetic process of a convolutional neural network on numerical values of a first three-dimensional array arranged in a first direction with a length represented by a first numerical value, arranged in a second direction with a length represented by a second numerical value larger than the first numerical value, and arranged in a third direction with a length represented by a third numerical value, using a type of kernel, formed of numerical values of a second three-dimensional array arranged in the first direction with a length represented by a fourth numerical value, arranged in the second direction with a length represented by a fifth numerical value, and arranged in the third direction with a length represented by the third numerical value, where a number of the type of kernel is represented by a sixth numerical value, with a stride represented by a seventh numerical value in the first direction and a stride represented by an eighth numerical value in the second direction. The storage device is configured to store at least part of the numerical values of the first three-dimensional array, wherein the at least part of the numerical values includes numerical values of a third three-dimensional array arranged in the first direction with a length represented by the first numerical value, arranged in the second direction with a length represented by a sum of the fifth numerical value and the eighth numerical value, and arranged in the third direction with a length represented by the third numerical value.

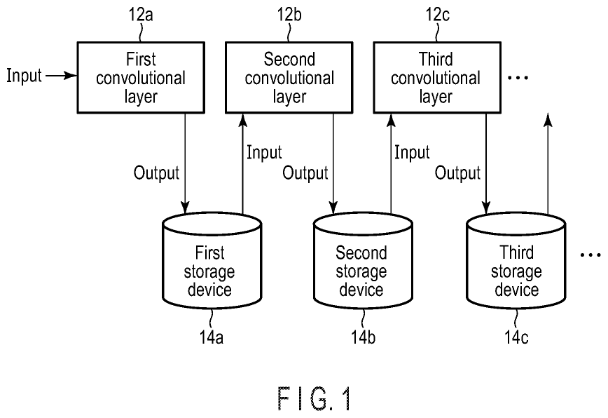

FIG. 1 is a schematic diagram illustrating an example of a convolutional neural network. The convolutional neural network includes a plurality of convolutional layers. In FIG. 1, the plurality of convolutional layers includes, as an example, a first convolutional layer 12a, a second convolutional layer 12b, and a third convolutional layer 12c.

The convolutional neural network receives a numerical value that is input, performs a convolutional arithmetic process of the first convolutional layer 12a on the input numerical value, and writes a first numerical value that is output of the first convolutional layer 12a to a first storage device 14a.

Subsequently, the convolutional neural network reads the first numerical value from the first storage device 14a, performs a convolutional arithmetic process of the second convolutional layer 12b on the first numerical value, and writes a second numerical value that is output of the second convolutional layer 12b to a second storage device 14b.

Subsequently, the convolutional neural network reads the second numerical value from the second storage device 14b, performs a convolutional arithmetic process of the third convolutional layer 12c on the second numerical value, and writes a third numerical value that is output of the third convolutional layer 12c to a third storage device 14c.

In this manner, the convolutional neural network sequentially performs the convolutional arithmetic processing by the convolutional layer.

In this method, the storage devices 14a, 14b, and 14c that can store the output numerical values of all the convolutional layers are required.

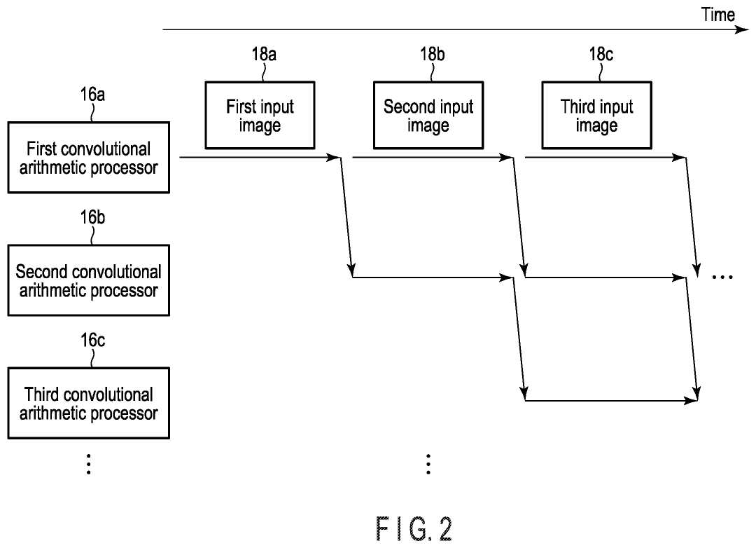

FIG. 2 schematically illustrates a pipeline process using each convolutional layer as a unit of processing in the convolutional neural network illustrated in FIG. 1. It is assumed that the input numerical value is an image. The image may be subjected to a preprocess and then input to the convolutional neural network. A result of the preprocess is also referred to as input image. The convolutional neural network includes the same number of convolutional arithmetic processors 16a, 16b, and 16c as the number of convolutional layers. The convolutional arithmetic processors 16a, 16b, and 16c perform the convolutional arithmetic processes of the convolutional layers 12a, 12b, and 12c, respectively.

When a first input image 18a is input, the first convolutional arithmetic processor 16a performs the convolutional arithmetic process of the first convolutional layer 12a on the first input image 18a, and writes output thereof to the first storage device 14a.

Subsequently, when a second input image 18b is input, the first convolutional arithmetic processor 16a performs the convolutional arithmetic process of the first convolutional layer 12a on the second input image 18b, and writes output thereof to the first storage device 14a. At the same time, the second convolutional arithmetic processor 16b performs the convolutional arithmetic process of the second convolutional layer 12b on the output of the convolutional arithmetic process of the first convolutional layer 12a for the first input image 18a read from the first storage device 14a, and writes output thereof to the second storage device 14b.

Subsequently, when a third input image 18c is input, the first convolutional arithmetic processor 16a performs the convolutional arithmetic process of the first convolutional layer 12a on the third input image 18c, and writes output thereof to the first storage device 14a. At the same time, the second convolutional arithmetic processor 16b performs the convolutional arithmetic process of the second convolutional layer 12b on the output of the convolutional arithmetic process of the first convolutional layer 12a for the second input image 18b read from the first storage device 14a, and writes output thereof to the second storage device 14b. At the same time, the third convolutional arithmetic processor 16c performs the convolutional arithmetic process of the third convolutional layer 12c on the output of the convolutional arithmetic process of the second convolutional layer 12b for the first input image 18a read from the second storage device 14b, and writes output thereof to the third storage device 14c.

In this way, the convolutional neural network realizes high-speed operation by performing the arithmetic process of each convolutional layer in parallel.

In order to enable such processing, it is necessary to read the output of the convolutional arithmetic process of the specific convolutional layer in order to perform the convolutional arithmetic process of a next convolutional layer following the specific convolutional layer while writing the output of the convolutional arithmetic process of the specific convolutional layer to each of the storage devices 14a, 14b, and 14c. That is, it is necessary to be able to simultaneously write or read numerical values to or from specific addresses in the storage devices 14a, 14b, and 14c and write or read numerical values to or from other specific addresses.

In order to enable such an operation, each storage device is required to store twice as many numerical values as the number of output numerical values of the convolutional layers to which the outputs of the convolutional arithmetic process are written, and alternately use them. Therefore, in this method, since it is necessary to be able to store twice as many numerical values as the number of output numerical values of all convolutional layers, a large size of memory is required.

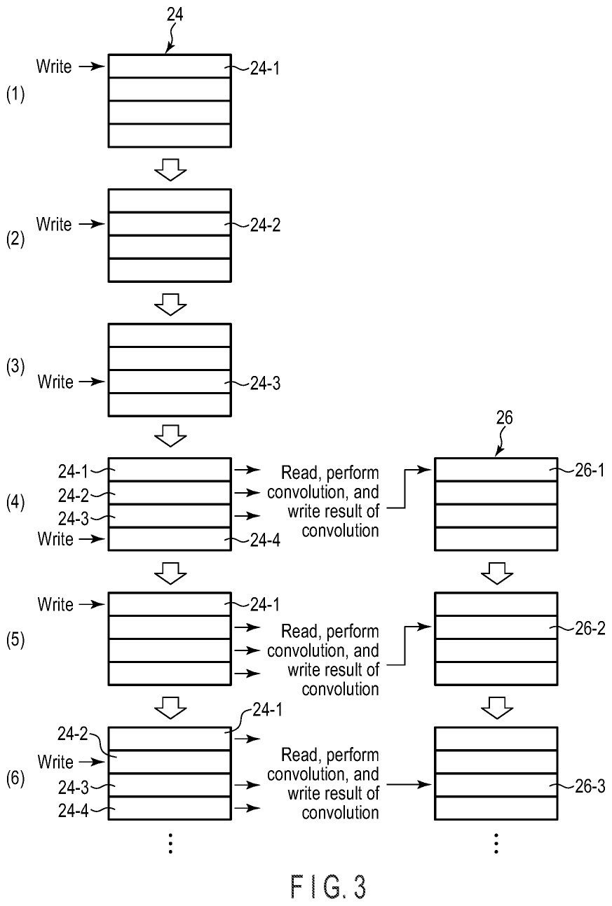

As a countermeasure against this, instead of storing all the output of each convolutional layer, it is considered to use a storage device including a memory which does not store all outputs of the convolutional arithmetic process of the convolutional layers, but which is capable of storing numerical values whose number is necessary to calculate one row of the output of the convolutional arithmetic process of the convolutional layer among the input of the convolutional arithmetic process of each convolutional layer. An example of a method of using such a storage device is schematically illustrated in FIG. 3.

The numerical values necessary for the convolutional arithmetic process of each convolutional layer are assumed to be a three-dimensional array of row, column, and channel. In FIG. 3, the channel direction is not illustrated, and the memory capable of storing the numerical value of one row of the convolutional arithmetic processing result is indicated by one rectangle. The kernel size of the convolutional arithmetic process is 3, and the stride is 1. Padding is not performed. When the input of the convolutional layer is an image, it is assumed that the input is numerical values three-dimensionally arranged in three directions of the row, the column, and the channel. When the input image includes a plurality of color components, for example, three color components of red, green, and blue, the color components are arranged in the channel direction.

First, the process of a first row of the output of the convolutional arithmetic process of a previous convolutional layer preceding the convolutional layer of interest is performed. Then, the numerical value of a first convolutional arithmetic processing result is written to a memory 24-1 at a first row of a storage device 24 for the convolutional layer of interest ((1) of FIG. 3).

Subsequently, the process of a second row of the output of the convolutional arithmetic process of the previous convolutional layer is performed. Then, the numerical value of a second convolutional arithmetic processing result is written to a memory 24-2 at a second row of the storage device 24 ((2) of FIG. 3).

Subsequently, the process of a third row of the output of the convolutional arithmetic process of the previous convolutional layer is performed. Then, the numerical value of a third convolutional arithmetic processing result is written to a memory 24-3 at a third row of the storage device 24 ((3) of FIG. 3).

Subsequently, the process of a fourth row of the output of the convolutional arithmetic process of the previous convolutional layer is performed. Then, the numerical value of a fourth convolutional arithmetic processing result is written to a memory 24-4 at a fourth row of the storage device 24. At the same time, numerical values are read from the memory 24-1 at the first row, the memory 24-2 at the second row, and the memory 24-3 at the third row of the storage device 24, and the process of the first row of the output of the convolutional arithmetic process of the convolutional layer of interest is performed. Then, the numerical value of the first convolutional arithmetic processing result is written to a memory 26-1 at a first row of a storage device 26 for a next convolutional layer following the convolutional layer of interest ((4) of FIG. 3).

Subsequently, the process of a fifth row of the output of the convolutional arithmetic process of the previous convolutional layer is performed. Then, the numerical value of a fifth convolutional arithmetic processing result is written to the memory 24-1 at the first row of the storage device 24. At the same time, numerical values are read from the memory 24-2 at the second row, the memory 24-3 at the third row, and the memory 24-4 at the fourth row of the storage device 24, and the process of a second row of the output of the convolutional arithmetic process of the convolutional layer of interest is performed. Then, the numerical value of the second convolutional arithmetic processing result is written to a memory 26-2 at a second row of the storage device 26 ((5) of FIG. 3).

Subsequently, the process of a sixth row of the output of the convolutional arithmetic process of the previous convolutional layer is performed, and the numerical value of the convolutional arithmetic processing result is written to the memory 24-2 at the second row of the storage device 24. At the same time, numerical values are read from the memory 24-3 at the third row, the memory 24-4 at the fourth row, and the memory 24-1 at the first row of the storage device 24, and the process of a third row of the output of the convolutional arithmetic process of the convolutional layer of interest is performed. Then, the numerical value of the third convolutional arithmetic processing result is written to a memory 26-3 at a third row of the storage device 26 ((6) of FIG. 3).

In this manner, the convolutional arithmetic process is performed. In this method, compared with the method of storing all of the output numerical values of each convolutional layer, the required size of the memory is reduced. However, an image is usually longer in a horizontal direction than in a vertical direction, and memory size reduction is insufficient. This method reduces the latency, but its reduction effect is insufficient.

When the maximum value pooling process is performed following the convolutional arithmetic process, a method of using only a storage device capable of storing only some of numerical values necessary for the pooling process is also considered.

### First Embodiment

The first embodiment of the convolutional arithmetic processing device will be described. As the first embodiment, a convolutional arithmetic processing device that performs the arithmetic process of a convolutional neural network on an image transmitted from an imaging device or an image obtained by performing a preprocess on the image such as a size change will be described. As an application target of the convolutional arithmetic processing device, for example, a monitoring camera that monitors entry of a person to a restricted area can be exemplified.

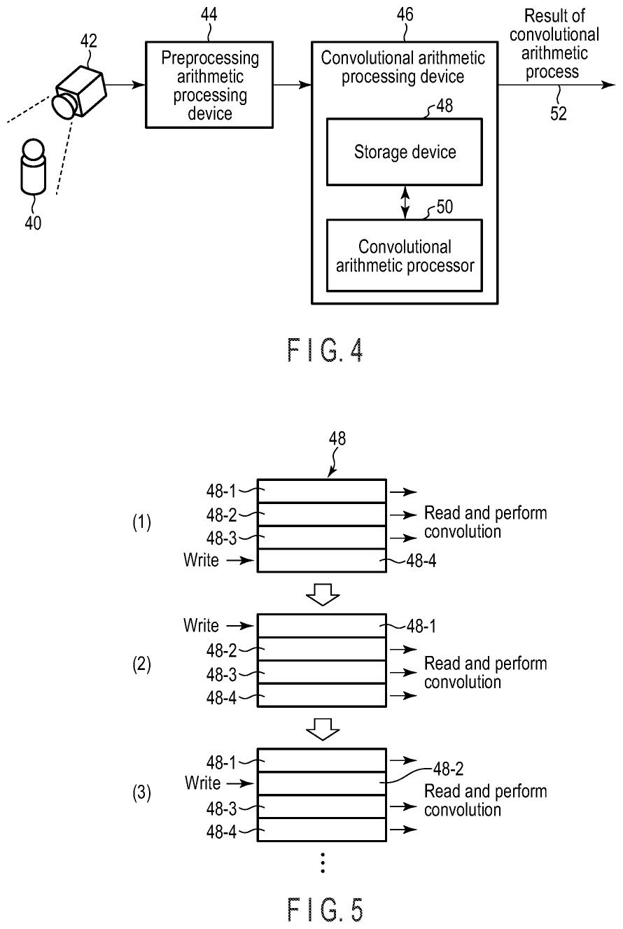

FIG. 4 schematically illustrates an example of a convolutional arithmetic processing device according to the first embodiment. In the arithmetic processing device of the first embodiment, an imaging device 42 captures an object 40 and transmits the image to a preprocessing arithmetic processing device 44. The preprocessing arithmetic processing device 44 performs a preprocess such as changing the size of the image on the received image, and transmits the processing result to a convolutional arithmetic processing device 46. The preprocess is not limited to the change in the size of the image, and for example, the process of color with respect to the image, extraction of only a specific region of the image, or the like may be performed. As a special case, the preprocessing arithmetic processing device 44 may directly transmit the image transmitted from the imaging device 42 to the convolutional arithmetic processing device 46 without performing the preprocess, or the imaging device 42 may directly transmit the image to the convolutional arithmetic processing device 46. In this case, it is also possible to consider that the preprocess is identity mapping.

The convolutional arithmetic processing device 46 includes a storage device 48 and a convolutional arithmetic processor 50. The convolutional arithmetic processing device 46 temporarily stores the received numerical value in the storage device 48. The convolutional arithmetic processor 50 reads the numerical value from the storage device 48, performs the convolutional arithmetic process of a desired convolutional neural network on the read numerical value to transmit the convolutional arithmetic processing result 52 to an output device (not illustrated). An example of the output device is a display. However, instead of the display, a communication device may be connected to the convolutional arithmetic processing device 46. The convolutional arithmetic processing result 52 output from the convolutional arithmetic processing device 46 may be transmitted to another device by the communication device.

The numerical value is not necessarily a single numerical value, and a set of a plurality of numerical values is also referred to as a numerical value in the present specification. Although one storage device 48 and one convolutional arithmetic processor 50 are illustrated in the convolutional arithmetic processing device 46, the storage device 48 and the convolutional arithmetic processor 50 may be provided for each of the convolutional layers constituting the convolutional neural network. In this case, the convolutional arithmetic processor 50 of each layer performs the convolutional arithmetic process of a desired convolutional layer on the numerical value read from each storage device 48 and stores the processing result in the storage device 48 of the next layer.

It is assumed that the convolutional neural network is configured by a desired number of convolutional layers, input of each convolutional layer is numerical values of a three-dimensional array, and an array direction corresponding to each dimension is hereinafter referred to as a row, a column, or a channel. In the image captured by the imaging device 42, the row and the column correspond to vertical and horizontal directions, and the channel corresponds to red, blue, and green colors. A row and a column may be a vertical direction and may be a horizontal direction, but in the present specification, a shorter one of vertical and horizontal directions is referred to as a row and the other is referred to as a column unless otherwise specified.

A method of the convolutional arithmetic process of a specific convolutional layer of the convolutional arithmetic processing device 46 will be described below. The storage device 48 can store numerical values of a three-dimensional array. Lengths of three directions of the array are a length of a row of input of a specific convolutional layer, a sum of a size in the column direction of a kernel used for the convolutional arithmetic process and a stride in the column direction, and the number of channels of the input of the convolutional layer. When comparing a case where a numerical value is stored in a storage or the like outside a chip that performs the arithmetic process with a case where a numerical value is stored in a memory inside the chip, the former has a longer time required for reading and writing than the latter. When a memory inside a chip including the convolutional arithmetic processor 50 is used as the storage device 48, a high speed operation is enabled.

The convolutional arithmetic process of the convolutional layer is performed as follows. FIG. 5 is a schematic diagram illustrating an example of a method of using the storage device 48 in the convolutional arithmetic processing device. In FIG. 5, the memory capable of storing the numerical value of one row of the input of the convolutional layer is represented by one rectangle, and the direction of the channel is not illustrated. A numerical value of a specific row of the input of the convolutional layer is written to the storage device 48. The numerical value of a specific row is a numerical value of a row of the sum of the size in the column direction of a kernel used for the convolutional arithmetic processing and the stride in the column direction. Here, a case where the size in the column direction of the kernel of the convolutional arithmetic process is 3 and the stride in the column direction is 1 will be described as an example. Therefore, the storage device 48 can store numerical values of 3+1=4 rows.

First, in the convolutional arithmetic process, a numerical value of a row necessary for calculation of a specific row in a result of the process is written to the storage device 48. Here, it is assumed that these numerical values are written to a memory 48-1 at a first row, a memory 48-2 at a second row, and a memory 48-3 at a third row of the storage device 48. In storing the numerical values forming the three-dimensional array in the storage device 48, an address is designated by a set of three numerical values of a numerical value designating the row, a numerical value designating the column, and a numerical value designating the channel. In the present embodiment, these three numerical values are referred to as address numerical values.

Writing of a numerical value of a specific row to the storage device 48 starts from an address at which both an address numerical value designating the column and an address numerical value designating the channel are a minimum value in a variable range.

The address numerical value designating the column and the address numerical value designating the channel are controlled by one of the following two control modes.

In the first control mode, every time a numerical value is newly written, an address numerical value designating a column is increased by one. When it is expected that it exceeds a maximum value in the variable range of the address numerical value designating the column as a result of the increase, the address numerical value designating the column is returned to the minimum value in the variable range without being increased by one, and the address numerical value designating the channel is increased by one. When it is expected that it exceeds a maximum value in the variable range of the address numerical value designating the channel as a result of the increase, the address numerical value designating the channel is returned to the minimum value in the variable range without being increased by one. The above operation is continued until returning to a state in which both of these two address numerical values are the minimum value in each variable range.

In the second control mode, the address numerical value designating the channel is increased by one each time a new numerical value is written. When it is expected that it exceeds the maximum value in the variable range of the address numerical value designating the channel as a result of the increase, the address numerical value designating the channel is returned to the minimum value in the variable range without being increased by one, and the address numerical value designating the column is increased by one. When it is expected as a result of the increase that it exceeds the maximum value in the variable range of the address numerical value designating the column, the address numerical value designating the column is returned to the minimum value in the variable range without being increased by one. The above operation is continued until returning to a state in which both of these two address numerical values are the minimum value in each variable range.

In this manner, the numerical value of the specific row is written to the storage device 48.

The convolutional arithmetic processor 50 reads the numerical values from the memory 48-1 at the first row, the memory 48-2 at the second row, and the memory 48-3 at the third row of the storage device 48, and performs the convolutional arithmetic process of a specific row of the output in the convolutional arithmetic process of the layer. In order to perform the process of the next row of the output of the convolutional arithmetic process of the convolutional layer, in addition to the numerical values of the above three rows already written to the storage device 48, the numerical value of the row for the stride in the column direction is required. In this description, since the stride in the column direction is 1, a numerical value of one row is required additionally. It is assumed that it is written to a memory 48-4 at the fourth row of the storage device 48.

When it is written, the convolutional arithmetic processor 50 reads the numerical values from the memory 48-2 at the second row, the memory 48-3 at the third row, and the memory 48-4 at the fourth row of the storage device 48, and performs the convolutional arithmetic process of the next row of the output in the convolutional arithmetic process of the layer. When waiting for completion of the convolutional arithmetic process of the row of the output described at the beginning, the convolutional arithmetic processor 50 can write the numerical value of the new one row to the memory 48-1 at the first row of the storage device 48, wait for completion of the writing, read the numerical values from the memory 48-3 at the third row, the memory 48-4 at the fourth row, and the memory 48-1 at the first row of the storage device 48, and perform the convolutional arithmetic process of the next row of the output in the convolutional arithmetic process of the layer.

However, as described above, when the convolutional arithmetic processor 50 stores the numerical value of the above-described new one row to the memory 48-4 at the fourth row of the storage device 48, the convolutional arithmetic processor 50 can write a new numerical value to the memory 48-4 at the fourth row of the storage device 48 ((1) of FIG. 5) in parallel with reading the numerical values of the memory 48-1 at the first row, the memory 48-2 at the second row, and the memory 48-3 at the third row, which have already been written to the storage device 48, and performing the convolutional arithmetic process of a specific row of the output in the convolutional arithmetic process of the layer, which results a high-speed operation.

Note that, in order to enable the convolutional arithmetic processor 50 to simultaneously read the numerical value from the storage device 48 to perform the convolutional arithmetic process and write a new numerical value in another row of the storage device 48, it is necessary to be able to simultaneously write or read a numerical value of a certain specific address of the storage device 48 and write or read a numerical value of another specific address.

Then, according to the convolutional arithmetic processor 50, writing or reading can be performed at the same time, that is, the process can be performed in parallel as described above. When writing of a new row is performed row by row, that is, when the numerical value of a specific row in the storage device 48 is written across all columns and all channels, and then the numerical value of the next row is written across all columns and all channels, it is possible to perform in parallel the convolutional arithmetic process of continuous convolutional layers, and as a result, a high-speed operation is obtained. Specifically, when the vertical length is constantly shorter than the horizontal length or the horizontal length is constantly shorter than the vertical length in numerical values of the three-dimensional array to be input in all the convolutional layers, it is possible to write the result of the convolutional arithmetic process of the specific convolutional layer row by row as described above in the storage device 48 of the convolutional arithmetic processing device 46 that performs the convolutional arithmetic process of the next convolutional layer without rearranging the convolutional arithmetic processing result of the specific convolutional layer. That is, since the latter input is the former output, the time required for rearranging the array is unnecessary, and thus the high-speed operation is possible.

In the first convolutional layer of the convolutional neural network, the input of the convolutional neural network is the input of the convolutional layer. Therefore, when the input of the convolutional neural network can be written to the memory of the convolutional layer without rearrangement, that is, when the input of the convolutional neural network is the input of the convolutional layer, the time required for rearrangement is unnecessary, so that the high-speed operation can be performed.

When such a condition is satisfied, the convolutional arithmetic processor 50 can write the numerical value of the next row of the input of the convolutional layer to the memory 48-1 at the first row of the storage device 48 in parallel with reading the numerical values from the memory 48-2 at the second row, the memory 48-3 at the third row, and the memory 48-4 at the fourth row of the storage device 48 and performing the convolutional arithmetic processing ((2) of FIG. 5). Further, the convolutional arithmetic processor 50 can perform the convolutional arithmetic process in such a manner in which the convolutional arithmetic processor 50 subsequently writes the numerical value of the next row of the input of the convolutional layer to the memory 48-2 at the second row of the storage device 48 in parallel with reading the numerical values from the memory 48-3 at the third row, the memory 48-4 at the fourth row, and the memory 48-1 at the first row of the storage device 48 and performing the convolutional arithmetic process ((3) of FIG. 5).

Note that, here, a case where the size in the column direction of the kernel of the convolutional arithmetic process is 3 and the stride in the column direction is 1 is described as an example, and thus the storage device 48 can store numerical values of 3+1=4 rows. In general, when the size in the column direction of the kernel is m and the stride in the column direction is n (m and n are both specific positive integers), the storage device 48 that stores the input of the convolutional layer is required to be able to store numerical values of (m+n) rows. In parallel with performing the process of a specific row among the output of the convolutional arithmetic process of the convolutional layer using the m rows of numerical values stored in the storage device 48, the numerical values of the next n rows of the input are written to the storage device 48.

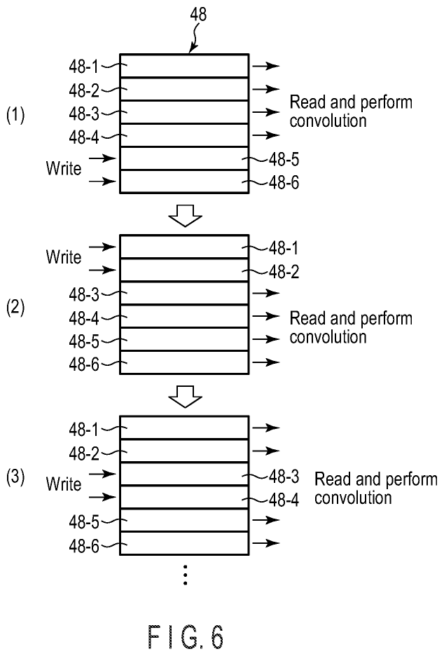

FIG. 6 schematically illustrates an example in which the size in the column direction of the kernel of the convolutional arithmetic process is 4 and the stride in the column direction is 2. In this case, the storage device 48 can store numerical values of 4+2=6 rows. In FIG. 6, the memory of the storage device 48 capable of storing the numerical value of one row of the input of the convolutional layer is represented by one rectangle, and the direction of the channel is not illustrated.

First, in the convolutional arithmetic process, a numerical value of a row necessary for calculation of a specific row in a result of the process is written to the storage device 48. It is assumed that they are written to the memory 48-1 at the first row, the memory 48-2 at the second row, the memory 48-3 at the third row, and the memory 48-4 in the fourth row. The convolutional arithmetic processor 50 reads the numerical values from the memory 48-1 at the first row, the memory 48-2 at the second row, the memory 48-3 at the third row, and the memory 48-4 at the fourth row, and performs the convolutional arithmetic process of a specific row of the output in the convolutional arithmetic process of the layer. In order to perform the process of the next row of the output of the arithmetic process of the layer, in addition to the above-described numerical values of the four rows already written to the storage device 48, the numerical values of the row for the stride in the column direction, that is, the numerical values of the two rows are required. It is assumed that they are written to a memory 48-5 at a fifth row and a memory 48-6 at a sixth row of the storage device 48 ((1) of FIG. 6).

When they are written, the convolutional arithmetic processor 50 reads the numerical values from the memory 48-3 at the third row, the memory 48-4 at the fourth row, the memory 48-5 at the fifth row, and the memory 48-6 at the sixth row of the storage device 48, and performs the convolutional arithmetic process of the next row of the output in the convolutional arithmetic process of the layer. Further, in order to perform the convolutional arithmetic process of the next row, numerical values of two rows are additionally required. It is assumed that they are written to the first row and the second row of the storage device 48 ((2) of FIG. 6).

When they are written, the convolutional arithmetic processor 50 reads the numerical values from the memory 48-5 at the fifth row, the memory 48-6 at the sixth row, the memory 48-1 at the first row, and the memory 48-2 at the second row of the storage device 48, and performs the convolutional arithmetic process of the further next row of the output in the convolutional arithmetic process of the layer ((3) of FIG. 6). In this manner, the convolutional arithmetic process is performed.

Normally, the size in the vertical direction and the size in the horizontal direction of the kernel of the convolutional arithmetic processing are set to be equal to each other. In addition, the stride in the vertical direction and the stride in the horizontal direction are set to be equal to each other.

Therefore, in the arithmetic processing device of the present embodiment, as compared with the case where the longer one of the horizontal length and the vertical length of the input of the specific convolutional layer is set as the row, the necessary size of the memory is reduced to (the shorter length of the vertical length and the horizontal length of the input of the convolutional layer)/(the longer length of the vertical length and the horizontal length of the input of the convolutional layer). As a result, since the size of the memory in the chip that performs the arithmetic process is reduced, it is possible to downsize the convolutional arithmetic processing device 46, and as a result, it is possible to reduce the manufacturing cost of the convolutional arithmetic processing device 46 and the arithmetic processing system including the convolutional arithmetic processing device 46.

In addition, in the arithmetic processing device 46 of the present embodiment, it is possible to shorten the delay time from the start of writing of the input of the specific convolutional layer to the storage device 48 to the start of outputting of the processing result of the convolutional arithmetic process of the convolutional layer. This will be described below including a case where the padding process of adding zero in a band shape having a specific width around the input numerical value is performed. Here, the zero width of the band shape to be added is referred to as the size of padding.

In the convolutional arithmetic process of the first row of the output of the processing result of the convolutional arithmetic process of the specific convolutional layer, the convolutional arithmetic processing can be started when there are rows for only values obtained by subtracting the size of the padding from the size of the kernel in the column direction at the start of the input of the convolutional layer. Normally, the size in the vertical direction and the size in the horizontal direction of the kernel of the convolutional arithmetic processing are set to be equal to each other. The size of the padding in the vertical direction and the size of the padding in the horizontal direction are set to be equal to each other. Therefore, in the arithmetic processing device of the present embodiment, as compared with a case where the longer one of the horizontal length and the vertical length of the input of the specific convolutional layer is set as the row, it is possible to shorten the delay time from the start of writing of the input of the specific convolutional layer to the storage device 48 to the start of outputting of the processing result of the convolutional arithmetic process of the convolutional layer to (the shorter length of the vertical length and the horizontal length of the input of the convolutional layer)/(the longer length of the vertical length and the horizontal length of the input of the convolutional layer). Specifically, when one of the vertical length and the horizontal length of the input of the convolutional layer is constantly shorter than the other in all the convolutional layers of the convolutional neural network, that is, when the horizontal length of the input of the convolutional layer is shorter than the vertical length across all the convolutional layers, or when the vertical length of the input of the convolutional layer is shorter than the horizontal length across all the convolutional layers, the delay time from the start of writing of the input of the convolutional neural network to the storage device 48 to the start of outputting of the processing result of the convolutional neural network is shortened. As a result, the delay time from the start of writing of the input of the convolutional neural network to the storage device 48 to the completion of outputting of the processing result of the convolutional neural network, that is the latency, is shortened.

Furthermore, in the present embodiment, only the process of the convolutional layer of the convolutional neural network is described. However, this does not mean that the convolutional neural network is configured only by the convolutional layer. The same effect can be obtained even when the convolutional neural network includes a layer other than the convolutional layer such as a fully connected layer or a transposed convolutional layer. Furthermore, although the number of convolutional layers has not been specified, a similar effect can be obtained regardless of the number of convolutional layers. Furthermore, a similar effect can be obtained even when pooling processing such as average value pooling or maximum value pooling is performed after the convolutional arithmetic processing.

Here, a monitoring camera that monitors entry of a person to a restricted area is described as an example. However, the application target is not limited to this example. The same effect can be obtained even when the monitoring camera is applied to, for example, observation of the situation of cows in livestock, observation of the situation of plants in cultivation, observation of the flow of people in a station, an underground mall, a shopping street, an event venue, or the like, observation of heavy traffic or a congestion situation on a road, or the like. Furthermore, the information to be captured is not limited to image information. A similar effect can be obtained even when the information is applied to an object other than an image, such as detection of abnormal noise in a factory or the like, detection of noise in a main road, a railway track, the periphery thereof, or the like, observation of atmospheric pressure, temperature, wind speed, or wind direction in weather observation.

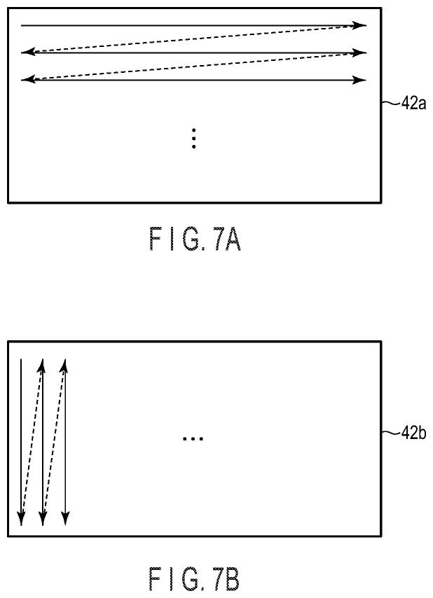

However, when the input of the convolutional neural network is an image captured by the imaging device 42 or an image obtained by performing the preprocess on the image, the following advantages can be obtained. As schematically illustrated in FIG. 7A, when a scanning direction of an image 42a captured by the imaging device 42 is a direction of the longer one of the vertical and horizontal lengths of the input of the convolutional neural network, in order for the convolutional arithmetic processing device 46 to perform the convolutional arithmetic process with the shorter one of the vertical and horizontal lengths of the input as a row as in the present embodiment, it is possible to start the pre-process or the convolutional arithmetic process only after the imaging device 42 completes the imaging of a specific image 42a.

On the other hand, as schematically illustrated in FIG. 7B, when a scanning direction of an image 42b captured by the imaging device 42 is a direction of the shorter one of the vertical and horizontal lengths of the input of the convolutional neural network, when the input of the convolutional neural network is the image 42b captured by the imaging device 42, the convolutional arithmetic process can be started when imaging of a sufficient number of rows to start the convolutional arithmetic process is completed, even when the convolutional arithmetic processing device performs the convolutional arithmetic process with the shorter one of the vertical and horizontal lengths of the input as a row as in the present embodiment. When the input of the convolutional neural network is an image obtained by performing the preprocess on the image 42b captured by the imaging device 42, when the imaging of a sufficient number of rows to start the preprocess is completed, the preprocess can be started even when the convolutional arithmetic processing device performs the convolutional arithmetic process with the shorter length of the vertical and horizontal lengths of the input as a row as in the present embodiment. Therefore, when a scanning direction of the image 42b captured by the imaging device 42 is a direction of the shorter length of the vertical and horizontal lengths of the input of the convolutional neural network, it is possible to shorten a delay from the start of the imaging of the specific image by the imaging device 42 to the output of the processing result of the convolutional arithmetic process of the image, that is, the latency.

Even when a scanning direction of the image captured by the imaging device 42 is a direction of the longer length of the vertical length and the horizontal length of the input of the convolutional neural network, it is possible to perform the convolutional arithmetic process by considering the longer length of the vertical length and the horizontal length in the convolutional arithmetic processing as a row. In this case, it is possible to start the preprocess or the convolutional arithmetic process before the imaging of a specific image by the imaging device 42 is completed. However, in such a case, a large size of memory is required, and the necessary size of the memory is not reduced. That is, when a scanning direction of the image captured by the imaging device 42 is a direction of the shorter length of the vertical and horizontal lengths of the input of the convolutional neural network, it is possible to reduce the necessary size of the memory and shorten the latency.

The convolutional arithmetic processing device 46 of the embodiment includes the convolutional arithmetic processor 50 and the storage device 48. The convolutional arithmetic processor 50 performs the convolutional arithmetic process of a specific convolutional layer in the convolutional neural network on the numerical value stored in the storage device 48. Here, numerical values of input of the convolutional layer are a three-dimensional array including a row and a column and a channel, and the row is shorter than the column. Then, the storage device 48 can store numerical values of the number of products of the length of the row, the sum of the size in the column direction of the kernel and the stride in the column direction of the convolutional arithmetic process of the convolutional layer, and the length of the channel. In the arithmetic processing device 46, since the number of numerical values required to be stored in the storage device 48 is reduced as compared with the conventional method, the size of the memory required for the storage device 48 can be reduced as compared with the conventional method. As a result, the manufacturing cost can be advantageously reduced. In addition, in the arithmetic processing device 46, it is also possible to shorten the latency as compared with the conventional case. Furthermore, the storage device 48 can simultaneously write or read a numerical value of a specific address and write or read a numerical value of another specific address. As a result, it is possible to simultaneously read a numerical value from the storage device 48 to perform the convolutional arithmetic process of a specific convolutional layer and perform the convolutional arithmetic process of a convolutional layer preceding to the specific convolutional layer in the convolutional neural network to write a result of the convolutional arithmetic process to the storage device 48. Therefore, since the process of the plurality of convolutional layers of the convolutional neural network can be performed in parallel, it is possible to realize a high-speed operation.

### Second Embodiment

As the second embodiment, a convolutional arithmetic processing system will be described in which the arithmetic process of a convolutional neural network is divided and performed on an image transmitted from an imaging device or an image obtained by performing the preprocess on the image such as size change. An example of the application target may include a monitoring camera that monitors entry of a person to a restricted area.

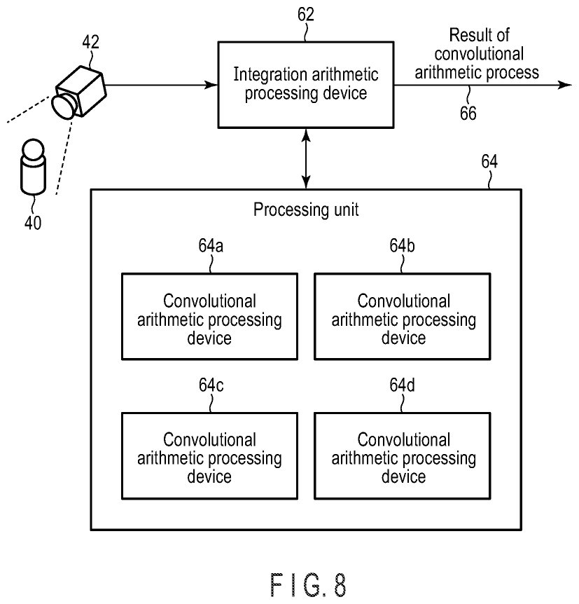

FIG. 8 is a schematic diagram illustrating an example of an arithmetic processing system according to the second embodiment. In the arithmetic processing system of the present embodiment, the imaging device 42 captures the object 40 and transmits the image to an integration arithmetic processing device 62. The integration arithmetic processing device 62 performs the preprocess such as a change in the size of the image, divides the processing result, and transmits the divided processing result to a plurality of, for example, four convolutional arithmetic processing devices 64a, 64b, 64c, and 64d included in the processing unit 64. The preprocess is not limited to the change in the size of the image, and the process of color of the image, extraction of only a specific region of the image, or the like may be performed.

Then, the plurality of convolutional arithmetic processing devices 64a, 64b, 64c, and 64d perform parts of the convolutional arithmetic process of a desired convolutional neural network on the received numerical values. Each of the convolutional arithmetic processing devices 64a, 64b, 64c, and 64d supplies the processing result to the integration arithmetic processing device 62. The integration arithmetic processing device 62 integrates them to output the integration result to an output device such as a display as the convolutional arithmetic processing result 66. Here, each of the plurality of convolutional arithmetic processing devices 64a, 64b, 64c, and 64d is the convolutional arithmetic processing device 46 described in the first embodiment. That is, although not illustrated in FIG. 8, each of the convolutional arithmetic processing devices 64a, 64b, 64c, and 64d includes a storage device and a convolutional arithmetic processor as in the convolutional arithmetic processing device 46.

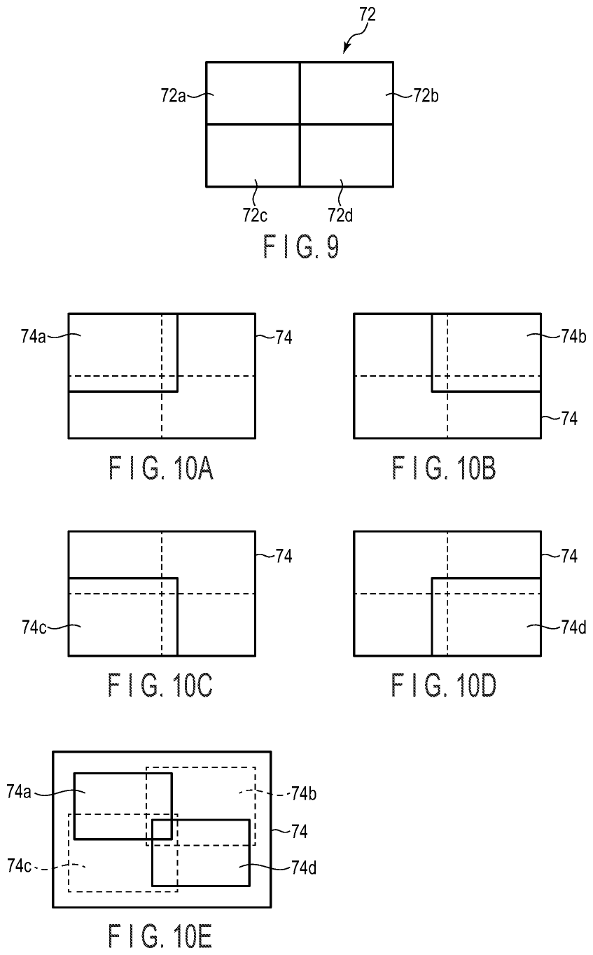

The division of the arithmetic process will be described. FIG. 9 is a schematic diagram illustrating an example of division of the output 72 of the convolutional neural network. The channel direction is perpendicular to the sheet, and the direction thereof is not illustrated in FIG. 9. The output 72 is divided into four sections 72a, 72b, 72c, and 72d whose number is equal to the number of the convolutional arithmetic processing devices 64a, 64b, 64c, and 64d. The output 72 is equally divided into two in both the vertical direction and the horizontal direction in FIG. 9. The four sections 72a, 72b, 72c, 72d include all the numerical values in the channel direction among the input of the convolutional neural network. The convolutional arithmetic processing devices 64a, 64b, 64c, and 64d performs the convolutional arithmetic process for calculating the sections 72a, 72b, 72c, and 72d of the output, respectively.

FIGS. 10A, 10B, 10C, 10D, and 10E schematically illustrate an example of division of the input 74 of the convolutional neural network necessary for calculating each of the sections 72a, 72b, 72c, and 72d of the output. The broken lines in FIGS. 10A to 10D bisect the input 74 in both the vertical direction and the horizontal direction. The channel direction is perpendicular to the sheet, and the direction is not illustrated in FIGS. 10A to 10E. When the convolutional arithmetic process is performed, one numerical value is calculated from the numerical values of the plurality of rows or columns. Thus, sections 74a, 74b, 74c, and 74d of division of the input necessary for the calculation of the respective sections 72a, 72b, 72c, and 72d of division of the output schematically illustrated in FIG. 9 overlap each other.

FIG. 10A illustrates the section 74a of the input necessary for calculating the section 72a of the output. FIG. 10B illustrates the section 74b of the input necessary for calculating the section 72b of the output. FIG. 10C illustrates the section 74c of the input necessary for calculating the section 72c of the output. FIG. 10D illustrates the section 74d of the input necessary for calculating the section 72d of the output.

FIG. 10E illustrates an example of a relationship among the sections 74a, 74b, 74c, and 74d of the input.

The upper side of the rectangle in a solid line representing the section 74a of the input necessary for calculation of the section 72a of the output, the upper side of the rectangle in a broken line representing the section 74b of the input necessary for calculation of the section 72b of the output, and the upper side of the rectangle representing the input 74 of the neural network actually overlap. However, in FIG. 10E, for visual clarity, the rectangle representing the input 74 of the neural network is illustrated slightly larger and the rectangle representing the section 74b of the input is illustrated larger than the rectangle representing the section 74a of the input so that the sides do not overlap.

The lower side of the rectangle in a broken line representing the section 74c of the input necessary for calculation of the section 72c of the output, the lower side of the rectangle in a solid line representing the section 74d of the input necessary for calculation of the section 72d of the output, and the lower side of the rectangle representing the input 74 of the neural network actually overlap. However, in FIG. 10E, for visual clarity, the rectangle representing the input 74 of the neural network is illustrated slightly larger and the rectangle representing the section 74c of the input is illustrated larger than the rectangle representing the section 74d of the input so that the sides do not overlap.

The left side of the rectangle representing the section 74a of the input necessary for calculation of the section 72a of the output, the left side of the rectangle representing the section 74c of the input necessary for calculation of the section 72c of the output, and the left side of the rectangle representing the input 74 of the neural network actually overlap. However, in FIG. 10E, for visual clarity, the rectangle representing the input 74 of the neural network is illustrated slightly larger and the rectangle representing the section 74c of the input is illustrated larger than the rectangle representing the section 74a of the input so that the sides do not overlap.

The right side of the rectangle representing the section 74b of the input necessary for calculation of the section 72b of the output, the right side of the rectangle representing the section 74d of the input necessary for calculation of the section 72d of the output, and the right side of the rectangle representing the input 74 of the neural network actually overlap. However, in FIG. 10E, for visual clarity, the rectangle representing the input 74 of the neural network is illustrated slightly larger and the rectangle representing the section 74b of the input is illustrated larger than the rectangle representing the section 74d of the input so that the sides do not overlap.

In the convolutional arithmetic processing system of the present embodiment, the convolutional arithmetic process is performed using the convolutional arithmetic processing devices 64a, 64b, 64c, and 64d same as the convolutional arithmetic processing device 46 of the first embodiment. Therefore, as in the convolutional arithmetic processing device 46 of the first embodiment, the size of the memory in the chip for performing the arithmetic process is reduced, the convolutional arithmetic processing devices 64a, 64b, 64c, and 64d can be downsized, and the manufacturing cost of the convolutional arithmetic processing devices 64a, 64b, 64c, and 64d and the arithmetic processing system including the convolutional arithmetic processing devices can be reduced. Furthermore, the delay time from the start of writing of the input of the specific convolutional layer to the storage device to the start of outputting of the processing result of the convolutional arithmetic process of the specific convolutional layer is shortened. Specifically, when one of the vertical and horizontal lengths of the input of the convolutional layer for which a specific convolutional arithmetic processing device performs the convolutional arithmetic process is constantly shorter than the other across all convolutional layers, that is, when the horizontal length of the input of the convolutional layer is shorter than the vertical length across all the convolutional layers, or when the vertical length of the input of the convolutional layer is shorter than the horizontal length across all the convolutional layers, the delay time from the start of writing of the input of the convolutional neural network to the storage device to the start of outputting of the processing result of the convolutional neural network is shortened. As a result, the delay time from the start of writing of the input of the convolutional neural network to the storage device to the completion of outputting of the processing result of the convolutional neural network, that is the latency, is shortened.

In order to obtain these advantages, it is not necessary that the horizontal length of the input is shorter than the vertical length across all the sections, or the vertical length of the input is shorter than the horizontal length across all the sections. The vertical length may be greater than the horizontal length of the input of a section and vice versa for another section. Also in this case, by considering the shorter one of the vertical and horizontal lengths of the input for each section as a row, the convolutional arithmetic processing device 46 of the first embodiment can be applied as the convolutional arithmetic processing devices 64a, 64b, 64c, and 64d, so that the same effect can be obtained.

In addition, not all the convolutional arithmetic processing devices 64a, 64b, 64c, and 64d have to be the convolutional arithmetic processing device 46 of the first embodiment. A similar effect can be obtained when at least one convolutional arithmetic processing device 64a, 64b, 64c, and 64d is the convolutional arithmetic processing device 46 of the first embodiment. However, when all the convolutional arithmetic processing devices 64a, 64b, 64c, and 64d are the convolutional arithmetic processing device 46 of the first embodiment, the obtained effect is maximized.

Further, in the present embodiment, the input of the convolutional neural network is divided into two in each of the vertical direction and the horizontal direction, that is, into four in total, but this is not essential. The number of divisions is not limited to four, and there is no need to divide the input into a lattice shape in the vertical direction and the horizontal direction. Each section is not required to have an equal shape. A similar effect can be obtained even with other division methods.

Specifically, a case where the output of the convolutional neural network is divided along the vertical length when the vertical length is shorter than the horizontal length of the input of the convolutional neural network will be considered. FIG. 11 schematically illustrates the division. The channel direction is perpendicular to the sheet, and the channel direction is not illustrated in the drawing. In this case, each section 76a, 76b, 76c, and 76d includes all numerical values in the horizontal direction in the output of the convolutional neural network, and includes all numerical values in the channel direction in the output of the convolutional neural network. An output 76 is equally divided into four in the vertical direction of FIG. 11.

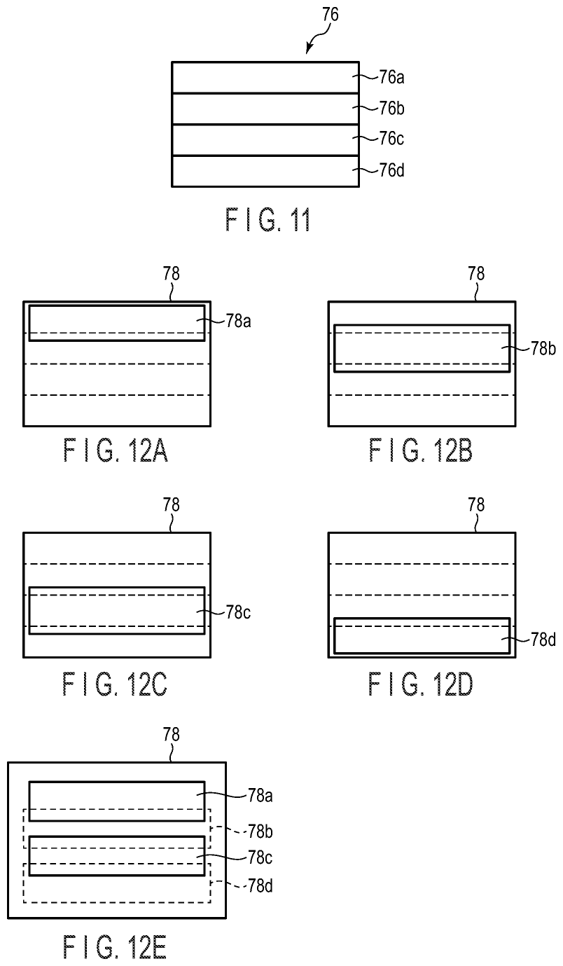

FIGS. 12A, 12B, 12C, 12D, and 12E schematically illustrate an example of division of an input 78 of the convolutional neural network necessary for the calculation of each of the sections 76a, 76b, 76c, and 76d of the output. Broken lines in FIGS. 12A to 12D are boundary lines that equally divide the input 78 into four sections 78a, 78b, 78c, and 78d along the vertical direction. The channel direction is perpendicular to the sheet, and the channel direction is not illustrated in FIGS. 12A to 12E. When the convolutional arithmetic process is performed, one numerical value is calculated from the numerical values of the plurality of rows or columns. Thus, the sections 78a to 78d of division of the input necessary for the calculation of the respective sections 76a to 76d of division of the output schematically illustrated in FIG. 11 overlap each other.

FIG. 12A illustrates the section 78a of the input necessary for calculating the section 76a of the output. FIG. 12B illustrates the section 78b of the input necessary for calculating the section 76b of the output. FIG. 12C illustrates the section 78c of the input necessary for calculating the section 76c of the output. FIG. 12D illustrates the section 78d of the input necessary for calculating the section 76d of the output. FIG. 12E illustrates an example of a relationship among the sections 78a to 78d of the input.

The upper side of the rectangle representing the section 78a of the input, and the upper side of the rectangle representing the input 78 of the neural network actually overlap. The lower side of the rectangle representing the section 78d of the input, and the lower side of the rectangle representing the input 78 of the neural network actually overlap. The right sides of the four rectangles representing the sections 78a to 78d of the input and the right side of the rectangle representing the input 78 of the neural network actually overlap. The left sides of the four rectangles representing the sections 78a to 78d of the input and the left side of the rectangle representing the input 78 of the neural network actually overlap. However, in FIGS. 12A to 12E, for visual clarity, the rectangle representing the input 78 of the neural network is illustrated slightly larger, so that the sides of the rectangle representing the input 78 of the convolutional neural network and the sides of the four rectangles representing the sections 78a to 78d of the input are illustrated so as not to overlap each other.

The right side and the left side of the rectangle in a solid line representing the section 78a of the input and the right side and the left side of the rectangle in a broken line representing the section 78b of the input are at the same positions. However, in FIG. 12E, for visual clarity, the rectangle representing the section 78b of the input is illustrated larger than the rectangle representing the section 78a of the input, and these sides are illustrated so as not to be at the same positions. In addition, the right side and the left side of the rectangle in a solid line representing the section 78c of the input and the right side and the left side of the rectangle in a broken line representing the section 78d of the input are at the same position. However, for visual clarity, the rectangle representing the section 78d of the input is illustrated larger than the rectangle representing the section 78c of the input so that the sides are not at the same position.

As described in the first embodiment, the larger the ratio of the longer one of the vertical and horizontal lengths of the input of each of the convolutional arithmetic processing devices 64a to 64d to the shorter one is, the greater the advantage obtained in both the reduction of the size of the memory in the chip on which the arithmetic process is performed and the reduction of the latency. Therefore, an advantage can be obtained when dividing the output of the convolutional neural network along the shorter one of the horizontal length and the vertical length of the input of the convolutional neural network in this manner.

Another example of division of the convolutional neural network will be described.

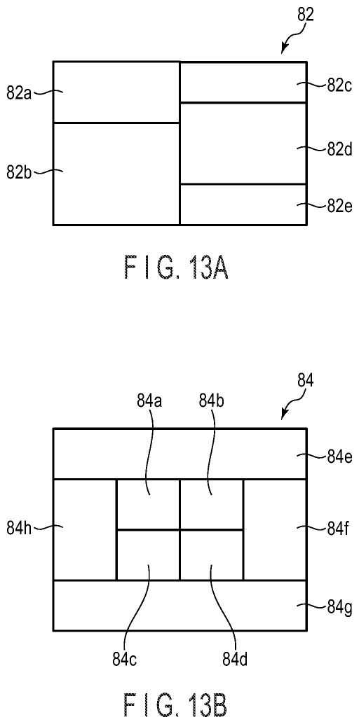

FIGS. 13A and 13B illustrate an example in which the output of the convolutional neural network is divided into different forms of section that are not all equal. Also in FIGS. 13A and 13B, the channel direction is perpendicular to the sheet, and the channel direction is not illustrated. All sections include all numerical values in the channel direction among the input of the convolutional neural network.

FIG. 13A illustrates an example in which an output 82 is divided into five sections 82a, 82b, 82c, 82d, and 82e having shapes different from each other but having the vertical length shorter than the horizontal length.

The output 82 is divided into two in the horizontal direction (not limited to two equal parts). The left divided region is divided into two in the vertical direction (not limited to two equal parts), and two sections 82a and 82b are obtained. The right divided region is divided into three in the vertical direction (not limited to three equal parts), and three sections 82c, 82d, and 82e are obtained.

FIG. 13B illustrates an example in which an output 84 is divided into eight sections 84a, 84b, 84c, 84d, 84e, 84f, 84g, and 84h having different shapes, including shapes having the vertical length shorter than the horizontal length and shapes having the horizontal length shorter than the vertical length.

The output 84 is divided into three in the vertical direction (not limited to three equal parts). The uppermost divided region is the section 84e, and the lowermost divided region is the section 84g. The section 84e and the section 84g have a shape having the vertical length shorter than the horizontal length. The section 84e and the section 84g include all the numerical values in the horizontal direction among the input of the convolutional neural network.

The central divided region is divided into three in the horizontal direction (not limited to three equal parts). The rightmost divided region is the section 84f, and the leftmost divided region is the section 84h. The section 84f and the section 84h have a shape having the horizontal length shorter than the vertical length. The central divided region is divided into a lattice shape, and sections 84a, 84b, 84c, and 84d are obtained. The sections 84a, 84b, 84c, 84d have a shape having the vertical length shorter the horizontal length.

Although not illustrated, as illustrated in FIGS. 10 and 12, the section of the input necessary for calculating each section of the output is represented by a rectangle larger than the section of the output.

The plurality of convolutional arithmetic processing devices 64a to 64d are used to perform the process in a divided manner. A large number of processes that cannot be performed by each of the convolutional arithmetic processing devices 64a to 64d can be performed in parallel. Therefore, it is possible to obtain an advantage that the high-speed operation can be performed as compared with a case where the process is performed by a single convolutional arithmetic processing device. That is, it is possible to obtain an advantage that high-speed operation can be performed even when each of the convolutional arithmetic processing devices 64a to 64d does not necessarily have a high processing capability. By lowering the operation frequency and the operation voltage, it is possible to obtain an advantage that consumed energy is reduced, compared with consumed energy at the same processing speed.

Further, in the present embodiment, the integration arithmetic processing device 62 performs the preprocess on an image and then transmits the image to each of the convolutional arithmetic processing devices 64a to 64d. However, the same effect can be obtained even when the integration arithmetic processing device 62 transmits an image to each of the convolutional arithmetic processing devices 64a to 64d only by dividing the input of a neural network without performing the preprocess, and each of the convolutional arithmetic processing devices performs the convolutional arithmetic process after performing the preprocess. Furthermore, a similar effect can be obtained even when the integration arithmetic processing device 62 merely divides the input of the neural network and transmits the image to each of the convolutional arithmetic processing devices 64a to 64d without performing the preprocess, and each of the convolutional arithmetic processing devices directly performs the convolutional arithmetic process on the received numerical value representing the image.

A monitoring camera that monitors entry of a person to a restricted area is described as an example, but the application target is not limited to this example. The same effect can be obtained even when the monitoring camera is applied to, for example, observation of the situation of cows in livestock, observation of the situation of plants in cultivation, observation of the flow of people in a station, an underground mall, a shopping street, an event venue, or the like, observation of heavy traffic or a congestion situation on a road, or the like. Furthermore, the input information is not limited to image information. A similar effect can be obtained even when the system is applied to an object other than an image, such as detection of abnormal noise in a factory or the like, detection of noise in a main road, a railway track, the periphery thereof, or the like, observation of atmospheric pressure, temperature, wind speed, or wind direction in weather observation.

When the input of the convolutional neural network is an image captured by the imaging device 42 or an image obtained by performing the preprocess on the image, and directions of the shorter length of the vertical and horizontal lengths of the input of the plurality of convolutional arithmetic processing devices 64a to 64d are all equal, the following advantages can be obtained. As schematically illustrated in FIG. 7A with respect to the modification of the first embodiment, a scanning direction of the image 42a captured by the imaging device 42 is a direction of the longer length of the vertical and horizontal lengths of the input of the plurality of convolutional arithmetic processing devices 64a to 64d. In order for the convolutional arithmetic processing devices 64a to 64d to perform the convolutional arithmetic process with the shorter length of the vertical and horizontal lengths of the input as a row as in the present embodiment, it is possible to start the preprocess or the convolutional arithmetic process only after the imaging device 42 completes the imaging of the specific image 42a. On the other hand, as schematically illustrated in FIG. 7B with respect to the modification of the first embodiment, a scanning direction of the image 42b captured by the imaging device 42 is a direction of the shorter length of the vertical and horizontal lengths of the input of the plurality of convolutional arithmetic processing devices 64a to 64d. When the imaging of a sufficient number of rows to start the convolutional arithmetic process is completed when the input of the convolutional neural network is the image 42b imaged by the imaging device 42, or when the imaging of a sufficient number of rows to start the preprocess is completed when the input of the convolutional neural network is an image obtained by performing the preprocess on the image 42b imaged by the imaging device 42, it is possible to start the convolutional arithmetic process or the preprocess in each case even when the convolutional arithmetic processing devices 64a to 64d perform the convolutional arithmetic process with the shorter one of the vertical and horizontal lengths of the input as a row as in the present embodiment. Therefore, when a scanning direction of the image captured by the imaging device 42 is a direction of the shorter length of the vertical and horizontal lengths of the input of the plurality of convolutional arithmetic processing devices 64a to 64d, it is possible to obtain an advantage that a delay from when the imaging device 42 starts imaging a specific image to when the processing result of the convolutional arithmetic process of the image is output, that is, the latency, is shortened. Even when a scanning direction of the image captured by the imaging device 42 is a direction of the longer length of the vertical and horizontal lengths of the input of the plurality of convolutional arithmetic processing devices 64a to 64d, it is possible to perform the convolutional arithmetic process by considering the longer length of the vertical length and the horizontal length in the convolutional arithmetic process as a row in the above. In this way, it is possible to start the preprocess or the convolutional arithmetic processing before the imaging of a specific image by the imaging device 42 is completed. However, in such a case, a large size of memory is required, and the size of the memory is not reduced. That is, when directions of the shorter length of the vertical and horizontal lengths of the input of the plurality of convolutional arithmetic processing devices 64a to 64d are all equal, and a scanning direction of the image captured by the imaging device 42 is a direction of the shorter length of the vertical and horizontal lengths of the input of the plurality of convolutional arithmetic processing devices 64a to 64d, it is possible to reduce a necessary size of the memory and the latency at the same time.

The convolutional arithmetic processing system of the second embodiment includes the plurality of convolutional arithmetic processing devices 64a to 64d. The output of the convolutional neural network is divided into the number as same the number of convolutional arithmetic processing devices 64a to 64d, and a numerical value necessary for calculating each of the output of the convolutional neural network among the input of the convolutional neural network is input of each of the plurality of convolutional arithmetic processing devices 64a to 64d. In this arithmetic processing system, since the convolutional neural network is divided into a plurality of convolutional arithmetic processing devices 64a to 64d and processed, the load of each of the convolutional arithmetic processing devices 64a to 64d can be reduced, and the parallelism of the process is increased. Therefore, even the convolutional arithmetic processing devices 64a to 64d that do not necessarily have high processing capability can perform the process of a large-scale convolutional neural network at high speed. Each of the plurality of convolutional arithmetic processing devices 64a to 64d satisfies the condition of the first embodiment. Therefore, it is possible to reduce a necessary size of the memory and the latency.

Furthermore, the convolutional arithmetic processing system according to the modification of the second embodiment includes the imaging device 42 and the plurality of convolutional arithmetic processing devices 64a to 64d. The image captured by the imaging device 42 is subjected to the preprocess and then input to the convolutional arithmetic processing devices 64a to 64d, and the convolutional arithmetic process is performed. Alternatively, the image captured by the imaging device 42 is input to the convolutional arithmetic processing devices 64a to 64d, subjected to the preprocess, and then the convolutional arithmetic process is performed. Each of the convolutional arithmetic processing devices 64a to 64d satisfies the condition of the first embodiment. Therefore, a required size of the memory size is reduced. In addition, the directions of the rows in all the convolutional arithmetic processing devices 64a to 64d are equal. In performing imaging by the imaging device 42, a scanning is performed in a direction corresponding to the row of the convolutional arithmetic processing devices 64a to 64d. In this arithmetic processing system, it is possible to start the preprocess or the convolutional arithmetic process without waiting for completion of capturing each image by the imaging device 42. As a result, it is possible to shorten a delay from the imaging until a result of the convolutional arithmetic process is obtained, that is, the latency.

While certain embodiments have been described, these embodiments have been presented by way of example only, and are not intended to limit the scope of the inventions. Indeed, the novel embodiments described herein may be embodied in a variety of other forms; furthermore, various omissions, substitutions, and changes in the form of the embodiments described herein may be made without departing from the spirit of the inventions. The accompanying claims and their equivalents are intended to cover such forms or modifications as would fall within the scope and spirit of the inventions.

1. A convolutional arithmetic processing device comprising:
a convolutional arithmetic processor configured to perform a first convolutional arithmetic process of a convolutional neural network on numerical values of a first three-dimensional array arranged in a first direction with a length represented by a first numerical value, arranged in a second direction with a length represented by a second numerical value larger than the first numerical value, and arranged in a third direction with a length represented by a third numerical value, using a type of kernel, formed of numerical values of a second three-dimensional array arranged in the first direction with a length represented by a fourth numerical value, arranged in the second direction with a length represented by a fifth numerical value, and arranged in the third direction with a length represented by the third numerical value, where a number of the type of kernel is represented by a sixth numerical value, with a stride represented by a seventh numerical value in the first direction and a stride represented by an eighth numerical value in the second direction; and
a storage device configured to store at least part of the numerical values of the first three-dimensional array, wherein the at least part of the numerical values includes numerical values of a third three-dimensional array arranged in the first direction with a length represented by the first numerical value, arranged in the second direction with a length represented by a sum of the fifth numerical value and the eighth numerical value, and arranged in the third direction with a length represented by the third numerical value.

2. The convolutional arithmetic processing device according to claim 1, wherein the third three-dimensional array includes an output of a second convolutional arithmetic process of the convolutional neural network or an input of the convolutional neural network.

3. The convolutional arithmetic processing device according to claim 1, wherein
a position of a numerical value of the third three-dimensional array stored in the storage device is designated by a first address numerical value designating a position in the first direction, a second address numerical value designating a position in the second direction, and a third address numerical value designating a position in the third direction,
the first address numerical value has a first variable range,
the second address numerical value has a second variable range,
the third address numerical value has a third variable range, and
the first address numerical value, the second address numerical value and the third address numerical value are controlled according to either a first method or a second method, wherein
in the first method,
the first address numerical value is increased by one each time a new numerical value is written to the storage device,
when the first address numerical value is expected to exceed a maximum value in the first variable range of the first address numerical value as a result of an increase, the first address numerical value is returned to a minimum value in the first variable range of the first address numerical value without being increased by one, and the third address numerical value is increased by one,
when the third address numerical value is expected to exceed a maximum value in the third variable range of the third address numerical value as a result of an increase, the third address numerical value is returned to a minimum value in the third variable range of the third address numerical value without being increased by one, and the second address numerical value is increased by one, and
when the second address numerical value is expected to exceed a maximum value in the second variable range of the second address numerical value as a result of an increase, the second address numerical value is returned to a minimum value in the second variable range of the second address numerical value without being increased by one, and
in the second method,
the third address numerical value is increased by one each time a new numerical value is written to the storage device,
when the third address numerical value is expected to exceed the maximum value in the third variable range of the third address numerical value as a result of an increase, the third address numerical value is returned to the minimum value in the third variable range of the third address numerical value without being increased by one, and the first address numerical value is increased by one,
when the first address numerical value is expected to exceed the maximum value in the first variable range of the first address numerical value as a result of an increase, the first address numerical value is returned to the minimum value in the first variable range of the first address numerical value without being increased by one, and the second address numerical value is increased by one, and
when the second address numerical value is expected to exceed the maximum value in the second variable range of the second address numerical value as a result of an increase, the second address numerical value is returned to the minimum value in the second variable range of the second address numerical value without being increased by one.

4. The convolutional arithmetic processing device according to claim 1, wherein
the convolutional neural network includes a plurality of convolutional layers, and
the convolutional arithmetic processing device comprises:
a plurality of convolutional arithmetic processors each of which performs a convolutional arithmetic process related to each of the convolutional layers; and
a plurality of storage devices each of which stores an input of each of the convolutional arithmetic processors.

5. The convolutional arithmetic processing device according to claim 1, wherein writing or reading with respect to a first position of the storage device and writing or reading with respect to a second position of the storage device are simultaneously performed, the second position being different from the first position.

6. The convolutional arithmetic processing device according to claim 5, wherein
the convolutional neural network includes a plurality of convolutional layers, and
the convolutional arithmetic processing device comprises:
a plurality of convolutional arithmetic processors each of which simultaneously performs a convolutional arithmetic process related to each of the convolutional layers; and
a plurality of storage devices each of which stores an input of each of the convolutional arithmetic processors.

7. A convolutional arithmetic processing system comprising a plurality of convolutional arithmetic processing devices, wherein
the convolutional arithmetic processing devices are configured to perform a first convolutional arithmetic process of a convolutional neural network,
an output of the convolutional neural network is divided into a same number as a number of the convolutional arithmetic processing devices,
a first convolutional arithmetic processing device in the convolutional arithmetic processing devices is configured to calculate a first value of the output of the convolutional neural network,
a second convolutional arithmetic processing device in the convolutional arithmetic processing devices is configured to calculate a second value of the output of the convolutional neural network, and
at least one of the convolutional arithmetic processing devices is a convolutional arithmetic processing device comprising:
a convolutional arithmetic processor configured to perform a first convolutional arithmetic process of a convolutional neural network on numerical values of a first three-dimensional array arranged in a first direction with a length represented by a first numerical value, arranged in a second direction with a length represented by a second numerical value larger than the first numerical value, and arranged in a third direction with a length represented by a third numerical value, using a type of kernel, formed of numerical values of a second three-dimensional array arranged in the first direction with a length represented by a fourth numerical value, arranged in the second direction with a length represented by a fifth numerical value, and arranged in the third direction with a length represented by the third numerical value, where a number of the type of kernel is represented by a sixth numerical value, with a stride represented by a seventh numerical value in the first direction and a stride represented by an eighth numerical value in the second direction; and
a storage device configured to store at least part of the numerical values of the first three-dimensional array, wherein the at least part of the numerical values includes numerical values of a third three-dimensional array arranged in the first direction with a length represented by the first numerical value, arranged in the second direction with a length represented by a sum of the fifth numerical value and the eighth numerical value, and arranged in the third direction with a length represented by the third numerical value.

8. The convolutional arithmetic processing system according to claim 7, wherein each of the convolutional arithmetic processing devices is a convolutional arithmetic processing device comprising:
a convolutional arithmetic processor configured to perform a first convolutional arithmetic process of a convolutional neural network on numerical values of a first three-dimensional array arranged in a first direction with a length represented by a first numerical value, arranged in a second direction with a length represented by a second numerical value larger than the first numerical value, and arranged in a third direction with a length represented by a third numerical value, using a type of kernel, formed of numerical values of a second three-dimensional array arranged in the first direction with a length represented by a fourth numerical value, arranged in the second direction with a length represented by a fifth numerical value, and arranged in the third direction with a length represented by the third numerical value, where a number of the type of kernel is represented by a sixth numerical value, with a stride represented by a seventh numerical value in the first direction and a stride represented by an eighth numerical value in the second direction, and
a storage device configured to store at least part of the numerical values of the first three-dimensional array, wherein the at least part of the numerical values includes numerical values of a third three-dimensional array arranged in the first direction with a length represented by the first numerical value, arranged in the second direction with a length represented by a sum of the fifth numerical value and the eighth numerical value, and arranged in the third direction with a length represented by the third numerical value.

9. The convolutional arithmetic processing system according to claim 7, wherein
an input of the convolutional neural network is numerical values of a three-dimensional array arranged in a ninth direction with a length represented by a ninth numerical value, arranged in a tenth direction with a length represented by a tenth numerical value larger than the ninth numerical value, and arranged in an eleventh direction with a length represented by an eleventh numerical value, and
each of the input of the convolutional neural network necessary for calculating each of the divided output of the convolutional neural network includes all numerical values of the input of the convolutional neural network in a direction along the tenth direction and all numerical values of the input of the convolutional neural network in a direction along the eleventh direction.

10. A convolutional arithmetic processing system comprising:
the convolutional arithmetic processing device according to claim 1; and
an imaging device, wherein
an input of the convolutional neural network is an image captured by the imaging device or an image obtained by performing a preprocess on the image captured by the imaging device, and
the imaging device is configured to capture an image by performing a scanning in the first direction of the convolutional arithmetic processing device.

11. The convolutional arithmetic processing system according to claim 7, further comprising
an imaging device, wherein
an input of the convolutional neural network is an image captured by the imaging device or an image obtained by performing a preprocess on the image captured by the imaging device,
the first direction of each of the convolutional arithmetic processing devices is equal to each other, and
the imaging device is configured to capture an image by performing a scanning in the first direction of each of the convolutional arithmetic processing devices.
